(19) United States
(12) Patent Application Publication
(10) Pub. No.: US 2011/0058063 A1
(43) Pub. Date: Mar. 10, 2011

(54) DIGITAL PHOTOGRAPHING APPARATUS, METHOD OF CONTROLLING THE SAME, AND RECORDING MEDIUM STORING PROGRAM TO EXECUTE THE METHOD

(75) Inventor: Dong-whan Lee, Seoul (KR)

(73) Assignee: Samsung Electronics Co., Ltd., Suwon-si (KR)

(21) Appl. No.: 12/877,268

(22) Filed: Sep. 8, 2010

(30) Foreign Application Priority Data
Sep. 9, 2009 (KR) 10-2009-0085068

(51) Int. Cl. H04N 9/73

(52) U.S. Cl. 348/223.1; 348/E09.051

(57) ABSTRACT

A digital photographing apparatus includes a manual white balance function for adjusting white balance according to a selected light source and a white balance bracketing function for capturing a plurality of images with a single shutter input, a method of controlling the same, and a recording medium storing a program to execute the method, wherein a user may adjust gains of white balance during generation of the plurality of images.

### CROSS-REFERENCE TO RELATED PATENT APPLICATION

This application claims the priority benefit of Korean Patent Application No. 10-2009-0085068, filed on Sep. 9, 2009, in the Korean Intellectual Property Office, the disclosure of which is incorporated herein in its entirety by reference.

### BACKGROUND

1. Field of the Invention

Embodiments relate to a digital photographing apparatus, a method of controlling the same, and a recording medium storing a program to execute the method, and more particularly, to a digital photographing apparatus capable of adjusting white balance, a method of controlling the same, and a recording medium storing a program to execute the method.

2. Description of the Related Art

When an image of a subject is captured using a digital photographing apparatus such as a digital camera or a digital camcorder, the impression of colors in a captured image often differs from the impression of colors of the subject recognized by the naked eyes. One of reasons of this difference is due to incorrect white balance. A digital photographing apparatus includes a white balance adjusting function to reproduce unique colors of a subject in a captured image, and the white balance adjusting function may be embodied by adjusting the gains of particular colors according to surrounding light.

Auto white balance (AWB) refers to a function for automatically performing white balance adjustment, whereas manual white balance (MWB) refers to a function where a user selects a light source illuminating a subject and manually adjusts the white balance according to the selected light source. However, gain values for red (R), green (G), and blue (B) preset by a manufacturer are used even in the case of capturing images with a MWB function, and thus, a precise adjustment of white balance is difficult. For example, when an image is captured indoors, a user adjusts the white balance by selecting a fluorescent lamp as a light source in a conventional digital photographing apparatus. However, since color temperatures of each fluorescent lamp slightly vary, the gain values set in a digital photographing apparatus may not be suitable for current photographing conditions.

### SUMMARY

Embodiments include a digital photographing apparatus capable of adjusting white balance, a method of controlling the same, and a recording medium storing a program to execute the method.

According to an embodiment, a digital photographing apparatus provides a manual white balance function by which a user selects a light source and adjusts white balance according to the selected light source. The digital photographing apparatus includes: a memory that stores basic R, G, and B gain set values for adjusting white balance according to the light source selected by the user, first modified R, G, and B gain set values of which R gain is modified, and second modified R, G, and B gain set values of which B gain is modified, with respect to each of the basic R, G, and B gain set values; an image capturing unit that captures an image of a subject and generates an image signal; a set value extracting unit that extracts basic R, G, and B gain set values corresponding to the selected light source, and first R, G, and B gain set values and second R, G, and B gain set values that are modified with respect to the basic R, G, and B gain set values; a gain correcting unit that changes the amount of modification of gains of the first modified R, G, and B gain set values and the second modified R, G, and B gain set values; and an image file generating unit that generates a first image file to which the basic R, G, and B gain set values are applied, a second image file to which the first modified R, G, and B gain set values are applied, and a third image file to which the second R, G, and B gain set values are applied.

The gain correcting unit may change the amount of modification of gain according to user manipulation.

The digital photographing apparatus may further include a graphical user interface (GUI) generating unit that generates light source icons indicating a plurality of light sources and an activation icon indicating a selected light source icon.

A size of the activation icon may be adjusted according to user manipulation, and the gain correcting unit may modify the R gain and the B gain in proportion to an amount that the size of the activation icon is adjusted.

The amount of modification of the R gain of the first modified R, G, and B gain set values and the amount of modification of the B gain of the second modified R, G, and B gain set values may be smaller than or equal to 2% of the basic R, G, and B gain set values.

According to another embodiment, a digital photographing apparatus provides a manual white balance function by which a user selects a light source and adjusts white balance according to the selected light source. The digital photographing apparatus includes a processor and a non-transitory storage medium that stores a program executable by the processor, the program executable by the processor to perform a method that includes a white balance bracketing function that generates a plurality of images exhibiting a different impression of colors therein by using basic R, G, and B gain set values for adjusting white balance according to the light source, first modified R, G, and B gain set values of which R gain is modified, and second modified R, G, and B gain set values of which B gain is modified, with respect to each of the basic R, G, and B gain set values, wherein the amount of modification of the R gain and the amount of modification of the B gain are changed according to user manipulation. Light source icons that indicate the selected light source and an activation icon may be displayed.

A size of the activation icon may be adjusted according to the user manipulation.

A gain correcting unit may modify the R gain and the B gain in proportion to an amount that the size of the activation icon is adjusted.

According to another embodiment, a method of controlling a digital photographing apparatus provides a manual white balance function by which a user selects a light source and adjusts white balance according to the selected light source. The method includes selecting a light source; extracting basic R, G, and B gain set values for adjusting white balance according to the light source, first modified R, G, and B gain set values of which R gain is modified, and second modified R, G, and B gain set values of which B gain is modified, with respect to each of the basic R, G, and B gain set values; changing the amount of modification of gains of the first modified R, G, and B gain set values and the second modified R, G, and B gain set values; capturing an image of a subject; generating an image signal; and generating a first image file to which the basic R, G, and B gain set values are applied, a second image file to which the first modified R, G, and B gain set values are applied, and a third image file to which the second R, G, and B gain set values are applied.

The method may further include receiving a direct input of the amount of modification of the gains.

Light source icons may indicate a plurality of light sources and an activation icon may indicate a selected light source icon.

The method may further include adjusting a size of the activation icon according to user manipulation, wherein the R gain and the B gain may be modified in proportion to an amount that the size of the activation icon is adjusted.

According to another embodiment, a non-transitory computer readable recording medium may have stored thereon a program executable by a processor for performing the method of controlling a digital photographing apparatus described above.

### BRIEF DESCRIPTION OF THE DRAWINGS

The above and other features and advantages will become more apparent by describing in detail exemplary embodiments with reference to the attached drawings in which:

FIG. 1 is a block diagram of the interior of a digital photographing apparatus, according to an embodiment;

FIG. 2A is a diagram showing a white balance GUI indicating a white balance bracketing function on a display unit in the digital photographing apparatus, according to an embodiment;

FIG. 2B is a diagram showing an adjustment of the size of an activation icon of the white balance GUI of FIG. 2A to adjust the amount of modification of gains, according to an embodiment;

FIG. 3 is a flowchart of a method of controlling the digital photographing apparatus, according to an embodiment;

FIG. 4 is a flowchart of a method of controlling the digital photographing apparatus, according to another embodiment; and

FIG. 5 is a flowchart of a method of controlling the digital photographing apparatus, according to another embodiment.

### DETAILED DESCRIPTION

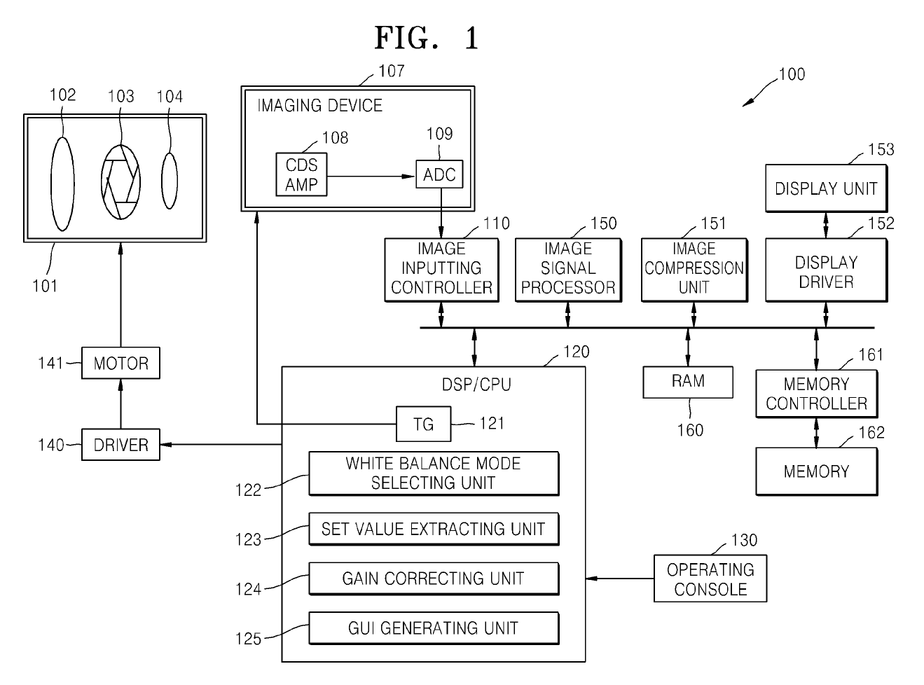

FIG. 1 is a block diagram of the interior of a digital photographing apparatus 100, according to an embodiment.

Referring to FIG. 1, the digital photographing apparatus 100 according to the present embodiment includes a manual white balance (MWB) function where a user selects a light source and manually adjusts the white balance according to the selected light source. The photographing apparatus 100 may include an imaging optics 101, an imaging device 107, an image inputting controller 110, a DSP/CPU 120, an operating console 130, a driver 140, a motor 141, an image signal processor 150, an image compression unit 151, a display driver 152, a display unit 153, a random access memory (RAM) 160, a memory controller 161, and a memory 162.

The imaging optics 101 includes a group of lenses: a zoom lens 102 and a focusing lens 104, and an iris 103. The imaging optics 101 is an optic system for imaging external optical information on the imaging device 107, and transmits light from a subject to the imaging device 107. The zoom lens 102 is a lens for changing an angle of view by changing a focusing distance. The iris 103 is a unit for controlling intensity of transmitted light. The focusing lens 104 focuses an image of a subject on an imaging surface of the imaging device 107 by moving along an optical axis. The zoom lens 102, the iris 103, and the focusing lens 104 are driven by the motor 141. Although FIG. 1 illustrates only one motor 141, each of the zoom lens 102, the iris 103, and the focusing lens 104 may have its own driver and motor. The motor 141 is driven in response to a driving signal from the driver 140.

The imaging device 107 is an example of a photoelectric device, and may include a plurality of photoelectric devices capable of converting optical information incident via the imaging optics 101 into electric signals. Each of the plurality of photoelectric devices generates an electric signal corresponding to received light. A charge-coupled device (CCD) sensor or a complementary metal-oxide semiconductor (CMOS) sensor may be used as the imaging device 107.

Furthermore, a mechanical shutter (not shown) or an electric shutter (not shown) may be used to block light incidence when an image is not being captured and to let light reach the imaging device 107 when an image is being captured, to control the light exposure time of the imaging device 107.

The imaging device 107 may further include a correlated double-sampling-amplifier (CDS-amp 108) and an analog-to-digital (A/D) converter 109. The CDS-amp 108 removes low frequency noise in electric signals output by the imaging device 107 and amplifies the electric signal to a predetermined level. The A/D converter 109 generates digital signals by digital-converting electric signals output by the CDS-amp 108. The A/D converter 109 outputs generated digital signals to the image inputting controller 110.

The image inputting controller 110 generates an image signal, which may be image-processed, by processing a digital signal output by the A/D converter 109. The image inputting controller 110 outputs the generated image signal to the image signal processor 150, for example. Furthermore, the image inputting controller 110 controls reading and writing of image data from and to the RAM 160. The imaging optics 101, the imaging device 107, and the image inputting controller 110 may constitute an example of a photographing unit which captures an image of a subject and generates image signals therefrom.

The DSP/CPU 120 functions as a processing unit and a control unit according to a program, and controls processes of each of the components within the digital photographing apparatus 100. For example, the DSP/CPU 120 drives the imaging optics 101 by outputting a signal to the driver 140 based on focus control or exposure control. Furthermore, the DSP/CPU 120 controls each of the components of the digital photographing apparatus 100 based on signals from the operating console 130. The DSP/CPU 120 may include a timing generator (TG) 121 which outputs a timing signal to the imaging device 107 or the CDS-amp 108 and controls the exposure time of, or reading of, each of the pixels constituting the imaging device 107. Although the present embodiment employs only one DSP/CPU 120, embodiments are not limited thereto, and thus, a plurality of DSP/CPUs may be employed such that commands based on signals and commands from an operating console are processed by separate CPUs, for example.

Meanwhile, the digital photographing apparatus 100 according to the present embodiment may include an auto white balance (AWB) function for automatically performing white balance adjustment and a MWB function for performing white balance adjustment according to a light source selected by a user. A user may select either of the white balance functions above.

In the case that the AWB function is executed, gain values with respect to each of R (red component), G (green component), and B (blue component) are calculated by analyzing generated image signals, and white balance is adjusted with the calculated gain values. In contrast, in the case that the MWB function is executed, when a light source is selected by a user, white balance is adjusted by using pre-stored R, G, and B gains according to the selected light source.

However, white balance is not always accurately adjusted even in the case where a user selects a light source for the MWB function. Pre-stored R, G, and B gains are values determined according to representative color temperatures of selected light sources. Therefore, slight differences exist between the impression of colors in an actual view and the impression of colors in a captured image, even if the image is captured using the MWB function.

Therefore, the digital photographing apparatus 100 according to the present embodiment may further include a white balance bracketing function for capturing a plurality of images with a single shutter input. Generally, a bracketing function refers to a function of capturing a plurality of images of the same subject with a single shutter input, wherein each of the plurality of images are captured in different photographing conditions. For example, image files according to three different exposure conditions may be generated with a single shutter input. The digital photographing apparatus 100 generates a plurality of images having different R, G, and B gains, that is, a plurality of images exhibiting different impression of colors therein by using the white balance bracketing function.

The memory 162 stores basic R, G, and B gain set values for adjusting white balance according to light sources for the white balance bracketing function. Here, examples of the light sources may include natural light, fluorescent light, incandescent light, and clouded light, wherein each of the light sources have different color temperatures. Furthermore, the memory 162 may store first modified R, G, and B gain values, in which R gains are corrected with respect to each of the basic R, G, and B gain set values corresponding to a light source, and second modified R, G, and B gain values, in which B gains are corrected with respect to each of the basic R, G, and B gain set values corresponding to the light source. In other words, the memory 162 may store three gain set values corresponding to a single light source. Table 1 below shows an example of gain values stored in a memory.

For example, when a user selects natural light as a light source, a set value extracting unit 123 of the DSP/CPU 120 (described below) may extract basic R, G, and B gain set values 430, 256, and 491 corresponding to natural light and first modified R, G, and B gain set values 439, 256, and 491 and second modified R, G, and B gain set values 430, 256, 501 with respect to the basic R, G, and B gain set values 430, 256, and 491.

TABLE 1

| Light Source | WB Gain | R Gain | G Bain | B Gain |
|---|---|---|---|---|
| Natural Light | Basic R, G, B Gain | 430 | 256 | 491 |
| | First Modified R, G, B | 439 | 256 | 491 |
| | Gain | | | |
| | Second Modified R, | 430 | 256 | 501 |
| | G, B Gain | | | |
| Clouded Light | Basic R, G, B Gain | 541 | 256 | 431 |
| | First Modified R, G, B | 552 | 256 | 431 |
| | Gain | | | |
| | Second Modified R, | 541 | 256 | 440 |
| | G, B Gain | | | |
| Fluorescent Light 1 | Basic R, G, B Gain | 482 | 256 | 538 |
| | First Modified R, G, B | 492 | 256 | 538 |
| | Gain | | | |
| | Second Modified R, | 482 | 256 | 549 |
| | G, B Gain | | | |
| Fluorescent Light 2 | Basic R, G, B Gain | 361 | 256 | 761 |
| | First Modified R, G, B | 368 | 256 | 761 |
| | Gain | | | |
| | Second Modified R, | 361 | 256 | 776 |
| | G, B Gain | | | |
| Incandescent Light | Basic R, G, B Gain | 273 | 256 | 1050 |
| | First Modified R, G, B | 278 | 256 | 1050 |
| | Gain | | | |
| | Second Modified R, | 273 | 256 | 1071 |
| | G, B Gain | | | |

As shown above, the memory 162 is capable of storing basic R, G, and B gain set values, first modified R, G, and B gain set values, and second modified R, G, and B gain set values corresponding to each of all selectable light sources.

Meanwhile, in the digital photographing apparatus 100 according to the present embodiment, the amount of modification of the R gain in the first modified R, G, and B gain set values with respect to the basic R, G, and B gain set values may be smaller than or equal to about 2%. In this regard, the amount of modification of the B gain in second modified R, G, and B gain set values with respect to the basic R, G, and B gain set values may be smaller than or equal to about 2%. The white balance bracketing function is a function for removing the slight differences between the impression of colors in an actual view and the impression of colors in a captured image. Thus, it is necessary to adjust appropriately the amount of modification of the R gain in the first modified R, G, and B gain set values and the amount of modification of the B gain in second modified R, G, and B gain set values. In case where the amount of modification is too significant, the impressions of colors in a plurality of images captured using the white balance bracketing function become too significant, and thus the purpose of the white balance bracketing function cannot be fulfilled. Thus, the appropriate amount of modification may be obtained from repeated experiments, and the white balance bracketing function may produce optimal results in the case where the amount of modification of the R gain and the amount of modification of B the gain are smaller than or equal to 2%.

As shown in FIG. 1, the DSP/CPU 120 may include a white balance mode selecting unit 122, a set value extracting unit 123, a gain correcting unit 124, and a graphical user interface (GUI) generating unit 125 to execute the white balance bracketing function as described above.

The white balance mode selecting unit 122 receives an operating signal from a user and executes a white balance mode selected by the user. Examples of the white balance mode may include AWB mode, MWB mode, and white balance bracketing mode. In the case where the white balance bracketing mode is selected by a user, the set value extracting unit 123, the gain correcting unit 124, and the graphical user interface (GUI) generating unit 125 operate to perform the white balance bracketing function.

The set value extracting unit 123 extracts basic R, G, and B gain set values corresponding to a light source selected by a user, first modified R, G, and B gain set values and second modified R, G, and B gain set values with respect to the basic R, G, and B gain set values from among basic R, G, and B gain set values, first modified R, G, and B gain set values, and second modified R, G, and B gain set values that are stored in the memory 162. For example, when a user selects natural light as a light source, the set value extracting unit 123 may extract basic R, G, and B gain set values 430, 256, and 491 corresponding to natural light and first modified R, G, and B gain set values 439, 256, and 491 and second modified R, G, and B gain set values 430, 256, 501 with respect to the basic R, G, and B gain set values 430, 256, and 501.

The gain correcting unit 124 changes the amount of modification of the R gain in the first modified R, G, and B gain set values and the amount of modification of the B gain in second modified R, G, and B gain set values. In other words, the gain correcting unit 124 may change the default amount of modification of the R gain and B gain, which are about 2%, to about 3% or about 4%, for example. A user may operate the digital photographing apparatus 100 to perform such changes of the amount of modification of gains. Furthermore, the amount of modification of gains may be changed by adjusting the size of an activation icon, as described below. However, the invention is not limited thereto, and thus, a user may input direct numbers to set the amount of modification of gains.

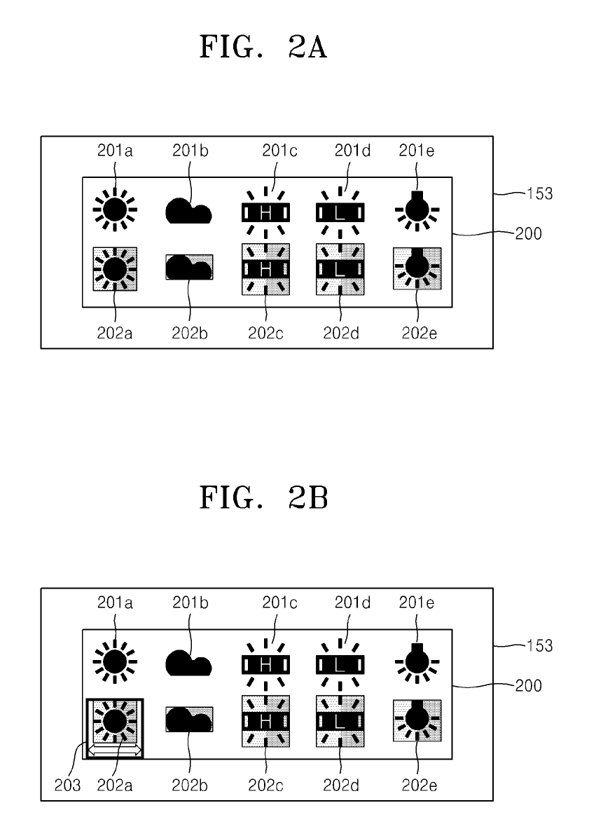

In the case where a user selects either a MWB mode or a white balance bracketing mode, the GUI generating unit 125 generates a plurality of light source icons 202a, 202b, 202c, 202d, and 202e (hereinafter referred to as 202a through 202e), which indicate selectable light sources, and displays the generated icons on the display unit 153 (see FIG. 2A). Furthermore, the GUI generating unit 125 may generate an activation icon 203, which indicates a light source currently selected from among the plurality of light source icons 202a through 202e, and may display the generated activation icon 203 on the display unit 153 (see FIG. 2B). Hereinafter, the plurality of light source icons 202a through 202e and the activation icon 203 will be described in detail in reference to FIGS. 2A and 2B.

FIG. 2A is a diagram showing a white balance GUI 200 indicating a white balance bracketing function on the display unit 153 in the digital photographing apparatus 100, according to the present embodiment, and FIG. 2B is a diagram showing an adjustment of the size of the activation icon 203 of the white balance GUI 200 to adjust the amount of modification of gains, according to the present embodiment.

When a user selects a white balance bracketing mode, the GUI generating unit 125 generates the white balance GUI 200 on the display unit 153. The white balance GUI 200 may include light source icons 201a, 201b, 201c, 201d, and 201e (hereinafter referred to as 201a through 201e) for a MWB mode and light source icons 202a through 202e for the white balance bracketing mode. Furthermore, the activation icon 203 indicating a currently selected light source is displayed together with the light source icons 201a through 201e and 202a through 202e. The activation icon 203 may be moved according to user manipulation.

Meanwhile, the size of the activation icon 203 may be adjusted according to user manipulation. The amount of change in size of the activation icon 203 may relate to the amount of modifications of the R gain and/or B gain in the gain correcting unit 124. For example, when the size of the activation icon 203 is increased as compared to the default size of the activation icon 203, the amount of modification of the R gain and/or the amount of modification of the B gain may be changed from 2% to a value greater than 2% in proportion to the amount of increased size of the activation icon 203. In contrast, when the size of the activation icon 203 is decreased as compared to the default size of the activation icon 203, the amount of modification of the R gain and/or the amount of modification of the B gain may be changed from 2% to a value smaller than 2% in proportion to the amount of decreased size of the activation icon 203.

The operating console 130 may include a power button, a shutter button, and various function buttons attached to the digital photographing apparatus 100, for example. Various operation signals from a user, e.g., a white balance mode selecting signal, a light source selecting signal, an activation icon 203 size adjusting signal, etc., may be applied by the operating console 130. Especially, the activation icon 203 size adjusting signal may be applied by directional buttons. For example, the size of the activation icon 203 may be increased when a user presses an up directional button, and the size of the activation icon 203 may be decreased when the user presses a down directional button.

The RAM 160 may temporarily store various data, and, although not shown, the RAM 160 may include an image or video RAM (VRAM) as a memory for image display and a synchronous DRAM (SDRAM) for temporarily storing image data of a captured image.

The memory controller 161 controls writing of image data to the memory 162 or reading out image data or setup information recorded in the memory 162. The memory 162 may be an optical disc (CD, DVD, Blu-ray Disc, etc.), an optomagnetic disc, a magnetic disc, or a semiconductor storage medium, and may store captured image data. The image data may be an image file generated by the image compression unit 151. The memory controller 161 and the memory 162 may be detachably attached to the digital photographing apparatus 100.

The image signal processor 150 receives an image signal from the image inputting controller 110 and generates an image signal which is image-processed based on gain values for white balance adjustment, a γ value, an outline emphasis control value, etc. In the present embodiment, the image signal processor 150 generates an image signal which is image-processed based on basic R, G, and B gain set values, first modified R, G, and B gain set values, and second modified R, G, and B gain set values that are extracted by the set value extracting unit 123. Furthermore, in the case where the amount of modification of the R gain and/or the amount of modification of the B gain are changed by the gain correcting unit 124, the image signal processor 150 generates an image signal which is image-processed by using the modified R gain and/or modified B gain.

The image compression unit 151 receives an uncompressed image signal and compresses the image signal in a compression format, such as a JPEG compression format or LZW compression format. The image compression unit 151 transmits an image file, which contains image data generated by a compressing operation, to the memory controller 161, for example. In the present embodiment, the image compression unit 151 is capable of generating a plurality of image files by using each of the image signals that are image-processed by using basic R, G, and B gain set values, first modified R, G, and B gain set values, and second modified R, G, and B gain set values.

Therefore, the image signal processor 150 and the image compression unit 151 may be examples of image file generating units.

The display driver 152 receives image data from the RAM 160 and displays an image of the image data on the display unit 153, for example. Images displayed by the display unit 153 may be an image before being captured (a live view image), various setting screens of the digital photographing apparatus 100, and images captured and recorded. Furthermore, the display unit 153 may also display the light source icons 202a through 202e and the activation icon 203 that are generated by the GUI generating unit 125. The display unit 153 and the display driver 152 may be a liquid crystal display (LCD) and an LCD driver. However, the invention is not limited thereto, and thus, the display unit 153 and the display driver 152 may also be an organic electroluminescent (EL) display and a display driver, respectively, for example.

Based on the configuration as described above, the digital photographing apparatus 100 according to an embodiment is capable of capturing an image of which the impression of colors therein is the same as the impression of colors of an actual view by capturing a plurality of images by using not only white balance gains corresponding to a light source selected by a user, but also white balance gains with a modified R gain value and a modified B gain value. Furthermore, the amounts of modifications of a R gain value and a B gain value with respect to white balance gains corresponding to a light source selected by a user may be adjusted by the user, so that the efficiency of the white balance function may be maximized. In other words, a user may easily capture an image with a correct white balance by using a digital photographing apparatus according to the present embodiment.

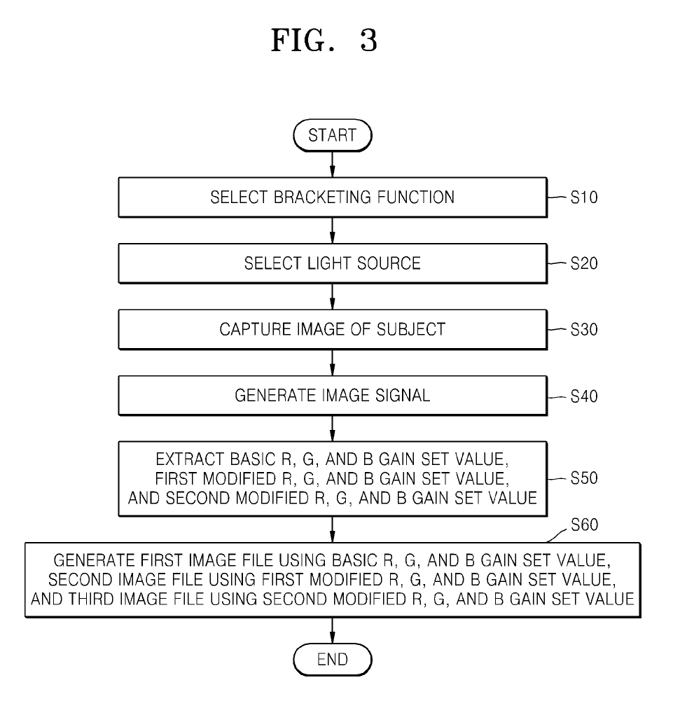

FIG. 3 is a flowchart of a method of controlling the digital photographing apparatus 100, according to an embodiment.

Referring to FIG. 3, when a white balance bracketing function is selected by a user (operation S10), light source icons that may be selected by a user are displayed.

When a light source is selected by the user (operation S20), an image of a subject is captured using white balance gains corresponding to the selected light source (operation S30).

An image signal, which is image-processed when the image is captured, is generated (operation S40), and the image signal may be displayed on the display unit 153 in real time as a live view image.

When a shutter input occurs, that is, when a user presses a shutter button, basic R, G, and B gain set values, first modified R, G, and B gain set values, and second modified R, G, and B gain set values are extracted (operation S50). Although the basic R, G, and B gain set values are extracted in the case where a shutter input occurs, the invention is not limited thereto. For example, the basic R, G, and B gain set values, the first modified R, G, and B gain set values, and the second modified R, G, and B gain set values may be extracted when a light source is selected by a user.

When a shutter input occurs, a plurality of image files are generated by using each of the image signals that are respectively image-processed by using the basic R, G, and B gain set values, the first modified R, G, and B gain set values, and the second modified R, G, and B gain set values (operation S60).

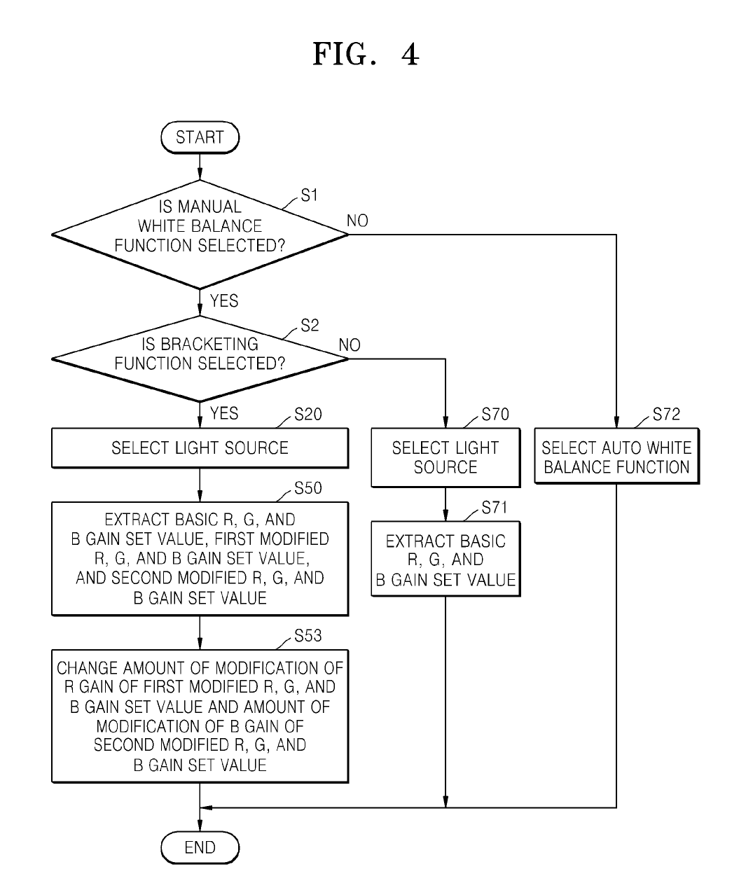

FIG. 4 is a flowchart of a method of controlling the digital photographing apparatus 100, according to another embodiment.

Referring to FIG. 4, a white balance mode selected by a user is determined (operation S1 and S2). If an AWB function is selected (operation S72), the DSP/CPU 120 automatically calculates white balance gains and white balance is adjusted based on the calculated white balance gains. Otherwise, if a MWB function is selected and not a white balance bracketing function, a light source is selected by a user (operation S70) and basic R, G, and B gain set values corresponding to the selected light source are extracted and used for the generation of image signals (operation S71).

If the white balance bracketing function is selected by a user, that is, a bracketing function is selected in a MWB mode, a light source is selected by the user (operation S20).

When a light source is selected, basic R, G, and B gain set values, first modified R, G, and B gain set values, and second modified R, G, and B gain set values, corresponding to the selected light source, are extracted (operation S50).

The amount of modification of the R gain of the first modified R, G, and B gain set values and the amount of modification of the B gain of the second modified R, G, and B gain set values may be changed according to user manipulation (operation S53).

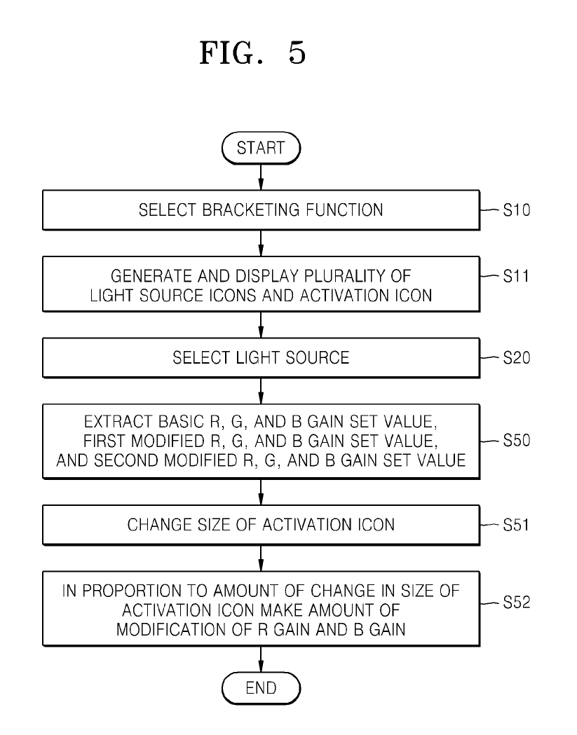

FIG. 5 is a flowchart of a method of controlling the digital photographing apparatus 100, according to another embodiment.

Referring to FIG. 5, when a bracketing function is selected in a MWB mode (operation S10), a plurality of light source icons and an activation icon are generated and displayed on the display unit 153 (operation S11).

The activation icon may be moved according to user manipulation, and a user selects a light source by moving the activation icon (operation S20).

When a light source for adjusting white balance is selected, basic R, G, and B gain set values, first modified R, G, and B gain set values, and second modified R, G, and B gain set values corresponding to the selected light source are extracted (operation S50).

A user may change the size of the activation icon by manipulating the operating console 130 (operation S51), where the amount of change in size of the activation icon may be in proportion to the amount of modifications of the R gain and/or B gain (operation S52).

Accordingly, a method of controlling the digital photographing apparatus 100 according to an embodiment enables capturing an image of which the impression of colors therein is the same as the impression of colors in an actual view by capturing a plurality of images by using not only white balance gains corresponding to a light source selected by a user, but also modified white balance gains of which R gain value and/or B gain values are modified with respect to the white balance gains corresponding to the light source. Furthermore, the amount of modifications of the R gain value and B gain value with respect to the white balance gains corresponding to the light source may be changed by a user for maximum efficiency of the white balance function. In other words, a method of controlling a digital photographing apparatus according to the embodiment enables a user to easily capture an image with a correct white balance.

A program for executing methods of controlling digital photographing apparatuses according to the present embodiment and embodiments modified thereof in a digital photographing apparatus may be stored in a non-transitory computer readable recording medium. Here, the recording medium may be either the memory 162 as shown in FIG. 1, for example, or other recording media. Any processes may be implemented as software modules or algorithms, and may be stored as program instructions or computer readable codes executable on the processor on a non-transitory computer-readable storage media such as flash memory, read-only memory (ROM), random-access memory (RAM), CD-ROM's, DVD's, magnetic tapes, floppy disks, hard disks, and optical data storage devices. The computer readable storage medium can also be distributed over network coupled computer systems so that the computer readable code is stored and executed in a distributed fashion. This computer readable code can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the present invention.

While the invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A digital photographing apparatus that provides a manual white balance function by which a user selects a light source and adjusts white balance according to the selected light source, the apparatus comprising:
a memory that stores basic R, G, and B gain set values for adjusting white balance according to the light source selected by the user, first modified R, G, and B gain set values of which R gain is modified, and second modified R, G, and B gain set values of which B gain is modified, with respect to each of the basic R, G, and B gain set values;
an image capturing unit that captures an image of a subject and generates an image signal;
a set value extracting unit that extracts basic R, G, and B gain set values corresponding to the selected light source, and first R, G, and B gain set values and second R, G, and B gain set values that are modified with respect to the basic R, G, and B gain set values;
a gain correcting unit that changes the amount of modification of gains of the first modified R, G, and B gain set values and the second modified R, G, and B gain set values; and
an image file generating unit that generates a first image file to which the basic R, G, and B gain set values are applied, a second image file to which the first modified R, G, and B gain set values are applied, and a third image file to which the second R, G, and B gain set values are applied.

2. The digital photographing apparatus of claim 1, wherein the gain correcting unit changes the amount of modification of gain according to user manipulation.

3. The digital photographing apparatus of claim 1, further comprising a graphical user interface (GUI) generating unit that generates light source icons indicating a plurality of light sources and an activation icon indicating a selected light source icon.

4. The digital photographing apparatus of claim 3, wherein a size of the activation icon is adjusted according to user manipulation, and
the gain correcting unit modifies the R gain and the B gain in proportion to an amount that the size of the activation icon is adjusted.

5. The digital photographing apparatus of claim 1, wherein the amount of modification of the R gain of the first modified R, G, and B gain set values and the amount of modification of the B gain of the second modified R, G, and B gain set values are smaller than or equal to 2% of the basic R, G, and B gain set values.

6. A digital photographing apparatus that provides a manual white balance function by which a user selects a light source and adjusts white balance according to the selected light source, the apparatus comprising a processor and a non-transitory storage medium that stores a program executable by the processor, the program executable by the processor to perform a method that includes a white balance bracketing function that generates a plurality of images exhibiting a different impression of colors therein by using basic R, G, and B gain set values for adjusting white balance according to the light source, first modified R, G, and B gain set values of which R gain is modified, and second modified R, G, and B gain set values of which B gain is modified, with respect to each of the basic R, G, and B gain set values, wherein the amount of modification of the R gain and the amount of modification of the B gain are changed according to user manipulation.

7. The digital photographing apparatus of claim 6, wherein light source icons that indicate the selected light source and an activation icon are displayed.

8. The digital photographing apparatus of claim 7, wherein a size of the activation icon is adjusted according to the user manipulation.

9. The digital photographing apparatus of claim 8, further comprising a gain correcting unit that modifies the R gain and the B gain in proportion to an amount that the size of the activation icon is adjusted.

10. A method of controlling a digital photographing apparatus that provides a manual white balance function by which a user selects a light source and adjusts white balance according to the selected light source, the method comprising:
selecting a light source;
extracting basic R, G, and B gain set values for adjusting white balance according to the light source, first modified R, G, and B gain set values of which R gain is modified, and second modified R, G, and B gain set values of which B gain is modified, with respect to each of the basic R, G, and B gain set values;
changing the amount of modification of gains of the first modified R, G, and B gain set values and the second modified R, G, and B gain set values;
capturing an image of a subject;
generating an image signal; and
generating a first image file to which the basic R, G, and B gain set values are applied, a second image file to which the first modified R, G, and B gain set values are applied, and a third image file to which the second R, G, and B gain set values are applied.

11. The method of claim 10, further comprising receiving a direct input of the amount of modification of the gains.

12. The method of claim 10, wherein light source icons indicate a plurality of light sources and an activation icon indicates a selected light source icon.

13. The method of claim 12, further comprising adjusting a size of the activation icon according to user manipulation,
wherein the R gain and the B gain is modified in proportion to an amount that the size of the activation icon is adjusted.

14. A non-transitory computer readable recording medium having stored thereon a program executable by a processor for performing a method of controlling a digital photographing apparatus that provides a manual white balance function by which a user selects a light source and adjusts white balance according to the selected light source, the method comprising:
selecting a light source;
extracting basic R, G, and B gain set values for adjusting white balance according to the light source, first modified R, G, and B gain set values of which R gain is modified, and second modified R, G, and B gain set values of which B gain is modified, with respect to each of the basic R, G, and B gain set values;
changing the amount of modification of gains of the first modified R, G, and B gain set values and the second modified R, G, and B gain set values;
capturing an image of a subject;
generating an image signal; and
generating a first image file to which the basic R, G, and B gain set values are applied, a second image file to which the first modified R, G, and B gain set values are applied, and a third image file to which the second R, G, and B gain set values are applied.

15. The computer readable recording medium of claim 14, wherein the method further comprises receiving a direct input of the amount of modification of the gains.

16. The computer readable recording medium of claim 14, wherein light source icons indicate a plurality of light sources and an activation icon indicates a selected light source icon.

17. The computer readable recording medium of claim 16, wherein the method further comprises adjusting a size of the activation icon according to user manipulation,
wherein the R gain and the B gain is modified in proportion to an amount that the size of the activation icon is adjusted.
